(19) United States
(12) Patent Application Publication
(10) Pub. No.: US 2018/0129930 A1
(43) Pub. Date: May 10, 2018

(54) LEARNING METHOD BASED ON DEEP LEARNING MODEL HAVING NON-CONSECUTIVE STOCHASTIC NEURON AND KNOWLEDGE TRANSFER, AND SYSTEM THEREOF

(71) Applicant: Korea Advanced Institute of Science and Technology, Daejeon (KR)

(72) Inventors: Jinwoo Shin, Daejeon (KR); Song Chong, Daejeon (KR); Kimin Lee, Daejeon (KR)

(73) Assignee: Korea Advanced Institute of Science and Technology, Daejeon (KR)

(21) Appl. No.: 15/365,641

(22) Filed: Nov. 30, 2016

(30) Foreign Application Priority Data
Nov. 7, 2016 (KR) 10-2016-0147329

(51) Int. Cl. G06N 3/04; G06N 3/08

(52) U.S. Cl. CPC G06N 3/04; G06N 3/08

(57) ABSTRACT

Disclosed is a learning method based on a stochastic-based deep learning model having a non-consecutive stochastic neural. The learning method includes configuring a non-consecutive stochastic feedforward neural network (NCSFNN) having non-consecutive stochastic neuron as a leaning model including a plurality of hidden layers; and allowing the NCSFNN to learn.

### CROSS-REFERENCE TO RELATED APPLICATIONS

A claim for priority under 35 U.S.C. § 119 is made to Korean Patent Application No. 10-2016-0147329 filed Nov. 7, 2016, in the Korean Intellectual Property Office, the entire contents of which are hereby incorporated by reference.

### BACKGROUND

Embodiments of the inventive concept relates to a learning model for supervised learning such as recognition and classification of things.

In a study of deep learning of a recent recognition system, instead of designing a background separation or feature extraction algorithm using experiential knowledge of human beings, the deep learning collects much data and allows a model to directly learn a corresponding role, thereby providing good performance.

Specifically, the deep learning provides innovative performance in a machine learning field such as a computer vision field, a voice recognition field, a natural language processing field, a signal processing field and the like in recent years.

As one example of a deep learning technique, there has been disclosed an apparatus and a method for training a convolutional neural network (CNN) for estimation of the CNN, which is capable of rapidly classifying image data in Korean Unexamined Patent Publication No. 10-2016-0069834 (published on Jun. 17, 2016).

Although the deep learning had been proposed in the 1940s, one of the main reasons that the deep learning technique comes into the spotlight in recent years is because a learning algorithm based on a stochastic component is developed.

One of methods capable of forcibly applying such a stochastic component is to design a stochastic deep learning model.

However, the current stochastic deep learning models have been limited to unsupervised learning. Thus, since it is obscure and complex how to design stochastic-based deep learning models for supervised learning, it is difficult to develop an effective learning algorithm.

### SUMMARY

Embodiments of the inventive concept provide a scheme of designing a novel deep learning model which is capable of making good performance in a supervised learning situation such as recognition and classification of things even though having the same number of variables as that of variables of a conventional deep learning model, and an effective learning scheme capable of allowing the corresponding model to learn rapidly.

According to an aspect of the inventive concept, a learning method includes configuring a non-consecutive stochastic feedforward neural network (NCSFNN) having non-consecutive stochastic neuron as a leaning model including a plurality of hidden layers; and allowing the NCSFNN to learn.

The configuring of the NCSFNN may include configuring a last layer of the NCSFNN as a non-stochastic neuron.

The configuring of the NCSFNN may include configuring the NCSFNN by replacing at least one of a deep neural network (DNN) with a stochastic layer.

The configuring of the NCSFNN may include configuring at least one among the hidden layers with a stochastic layer and configuring a last layer with a non-stochastic layer.

The configuring of the NCSFNN may include configuring a layer connected to an output of the stochastic layer with a deterministic layer.

The stochastic layer may be defined as a binary random vector having marginal distribution expressed as follows:

$$P ( {h}^{1} ; x ) = {\prod }_{i = 1}^{{N}^{1}} P ( {h}_{i}^{1} ; x ) with$$

$$P ( {h}_{i}^{1} = 1 ; x ) = g ( {α}_{1} f ( {W}_{i}^{1} x + {b}_{i}^{1} ) )$$

stochastic layer, Wᵢ¹ is an i-th weight matrix of the stochastic layer, bᵢ¹ is an i-th bias of the stochastic layer, f: [symbol] → [symbol] + is a non-negative activation function, and g(x)=min(max(x,0), 1), α₁>0 is a parameter of the stochastic layer.

The non-stochastic layer may be defined as a deterministic vector expressed as follows:

h²(x)=[f(α₂( [symbol] _{P(h}_{¹}_{;x)} [s(Wⱼ²h¹+bⱼ²)]−s(0))):∀j ∈ N²]

wherein x is data to be learned, N² is a number of hidden units of the non-stochastic layer, Wⱼ² is an j-th weight matrix of the non-stochastic layer, bⱼ² is an j-th bias of the non-stochastic layer, f: [symbol] → [symbol] + is a non-negative activation function, α₂>0 is a parameter of the non-stochastic layer, and s: [symbol] → [symbol] is a non-linear activation function.

The allowing of the NCSFNN to learn may be performed based on a knowledge transfer and gradient estimation.

The allowing of the NCSFNN to learn may include setting a parameter of the NCSFNN through linear transformation by using a parameter of the DNN.

The allowing of the NCSFNN to learn include allowing the NCSFNN to learn in a two-stage learning scheme of allowing the DNN to learn and allowing the NCSFNN to learn after a parameter of the NCSFNN is set by using a parameter of the DNN learned.

The NCSFNN may be used for supervised learning for recognizing a thing or a voice.

According to another aspect of the inventive concept, a learning method may include: configuring a non-consecutive stochastic feedforward neural network (NCSFNN) by replacing at least one non-consecutive layer with a stochastic layer in a deep neural network (DNN) including a plurality of hidden layers; and allowing the NCSFNN to learn based on a knowledge transfer and gradient estimation.

According to still another aspect of the inventive concept, a learning method includes: configuring a non-consecutive stochastic feedforward neural network (NCSFNN) by replacing at least one non-consecutive layer with a stochastic layer in a deep neural network including a plurality of hidden layers; and allowing the NCSFNN to learn in a two-stage learning scheme of allowing the DNN to learn and allowing the NCSFNN to learn after a parameter of the NCSFNN is set by using a parameter of the DNN learned.

According to still another aspect of the inventive concept, a learning system implemented by a computer includes at least one processor implemented to execute an instruction readable by the computer, wherein the at least one processor configures a non-consecutive stochastic feedforward neural network (NCSFNN) by replacing at least one non-consecutive layer with a stochastic layer in a deep neural network including a plurality of hidden layers.

According to the inventive concept, a scheme of designing a novel deep learning model which is capable of making good performance in a supervised learning situation such as recognition and classification of things even though having the same number of variables as that of variables of a conventional deep learning model, and an effective learning scheme capable of allowing the corresponding model to learn rapidly may be provided.

In addition, according to the inventive concept, the learning time may be reduced by using knowledge transfer between the non-stochastic model and the stochastic model, and fast and excellent performance may be obtained by setting the initial values of a learning model by using parameters of the non-stochastic model.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIGS. 1 and 2 are views illustrating a configuration of a non-consecutive stochastic feedforward neural network (NCSFNN) according to an embodiment of the inventive concept;

FIGS. 3 and 4 are views illustrating the structural limitation of NCSFNN according to an embodiment of the inventive concept;

FIG. 5 is a view illustrating a structure of NCSFNN having two hidden layers according to an embodiment of the inventive concept; and

FIG. 6 is a view illustrating a structure of NCSFNN having four hidden layers according to an embodiment of the inventive concept.

### DETAILED DESCRIPTION

Hereinafter, exemplary embodiments of the inventive concept will be described in detail with reference to the accompanying drawings.

Embodiments of the inventive concept relate to a stochastic-based deep learning model and a learning algorithm and are applicable to a supervised learning field such as recognition and classification of things or voice recognition (for example, in schools or companies).

Although most unsupervised learning is implemented through a stochastic-based deep learning model, non-stochastic-based deep learning models are applied to most supervised learning. The reason is because it is obscure how to design stochastic-based models for the purpose of supervised learning and knowledge expression and it is difficult to develop an effective learning algorithm due to complexity even though a specific model is designed.

To solve the problems, in embodiment of the inventive concept, a stochastic-based deep learning model having a non-consecutive stochastic neuron is designed, so that it is possible to transfer knowledge from a non-stochastic-based deep learning model having the same structure through such a structural limitation. In addition, embodiments of the inventive concept may provide a model learning scheme based on knowledge transferring and Monte Carlo estimation such that a new deep learning model, which is capable of effectively learning and making good performance, is provided.

The deep neural network (DNN) makes good performance in supervised artificial intelligence (AI) task such as recognition of a voice or a thing. The fact that the DNN makes good performance implies that the DNN has a stochastic property such as dropout or drop-connect. One of the most aggressive methods capable of applying a stochastic property is to design a stochastic-based model.

The stochastic-based model may represent a more complex model and may effectively extract more useful features from data. However, until now, the stochastic-based model has been applied to unsupervised learning but not to supervised learning.

Thus, the inventive concept proposes a non-consecutive stochastic feedforward neural network (NCSFNN) which is a novel stochastic model capable of making more improved performance in supervised learning.

An embodiment of the inventive concept includes (1) a new type of a deep learning model having a non-consecutive stochastic neuron and usable for supervised learning, and (2) an effective learning method capable of allowing a newly designed model to learn based on knowledge transferring.

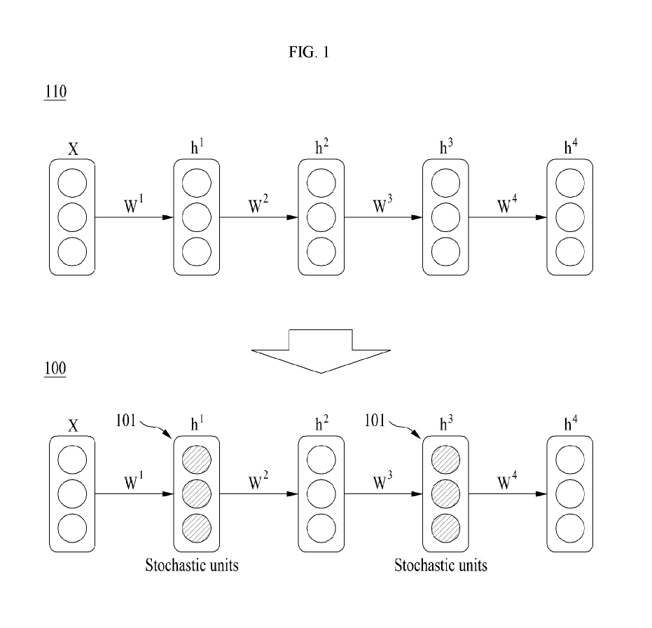

FIG. 1 is a view illustrating a configuration of a non-consecutive stochastic feedforward neural network (NCSFNN) according to an embodiment of the inventive concept

As shown in FIG. 1, a stochastic-based model NCSFNN 100 according to an embodiment of the inventive concept may be configured by replacing some layers of a conventional DNN 110 with a stochastic layer 101.

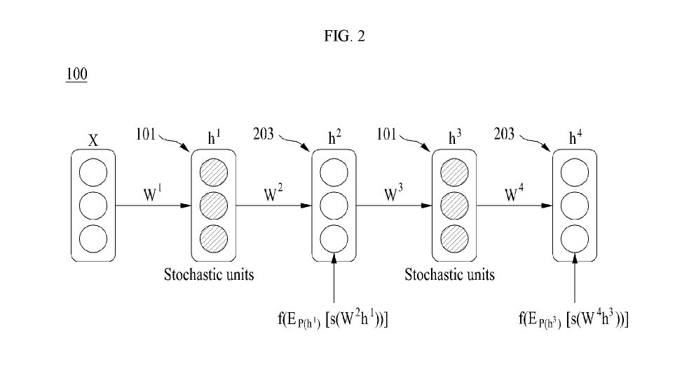

As shown in FIG. 2, the greatest feature of the stochastic-based model NCSFNN 100 is to configure a layer above the stochastic layer 101 as a deterministic layer 203. In other words, a layer connected to an output of the stochastic layer 101 may be configured as the deterministic layer 203. The deterministic layer 203 may be defined by using two non-linear activation functions of “f” and “s” and expectation.

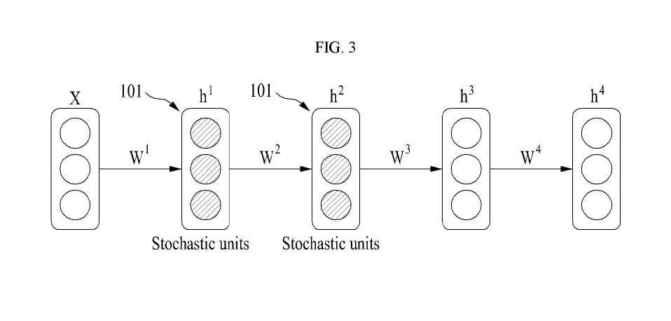

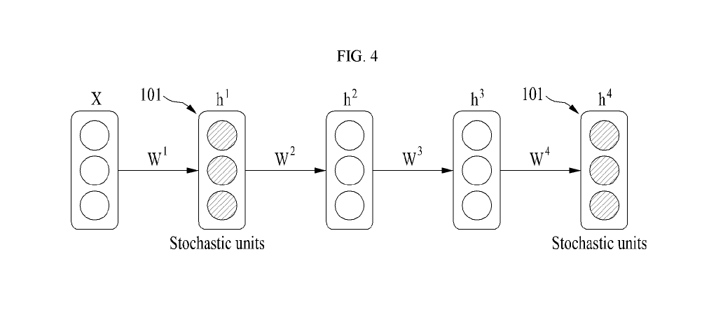

The stochastic-based model NCSFNN 100 according to an embodiment does not permit consecutive stochastic layers 101 as shown in FIG. 3, and the last layer configured as a stochastic layer 101 as shown in FIG. 4. Thus, the NCSFNN 100 capable of transferring knowledge for the DNN may be designed through such a structural limitation.

Therefore, the stochastic-based model NCSFNN 100 according to an embodiment of the inventive concept may be implemented as a hybrid network having non-stochastic and stochastic neurons and has following structural limitations: (1) the stochastic-based model NCSFNN 100 has non-consecutive stochastic layers and (2) the last layer is always configured as a non-stochastic neuron.

When a parameter of the DNN is given and a parameter of the NCSFNN 100 is set through specific transformation, the NCSFNN 100 may represent the same function value as that of the DNN. In addition, two-stage learning scheme may be utilized to train the NCSFNN 100 taking into consideration that is possible for the NCSFNN 100 to transfer knowledge. By training the NCSFNN 100 using the two-stage learning scheme, the training time of the NCSFNN 100, of which the training speed is slow due to sampling, may be reduced and the NCSFNN 100 having more excellent performance than that of the DNN may be expected.

Hereinafter, a detailed model of the NCSFNN 100 will be described.

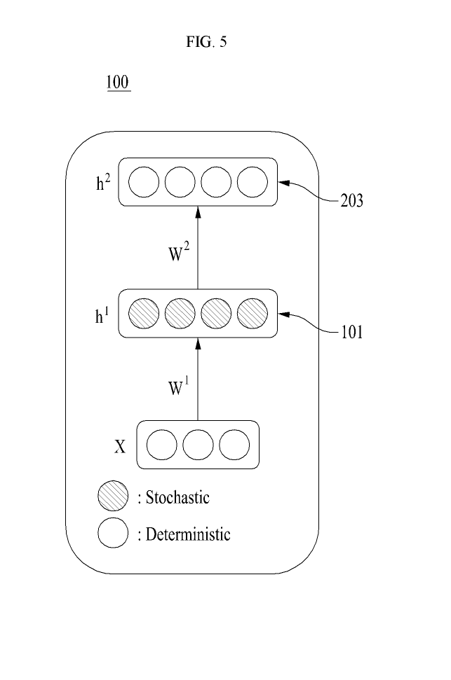

FIG. 5 shows an exemplary model of the NCSFNN 100 according to an embodiment of the inventive concept. FIG. 5 shows the NCSFNN 100 having two hidden layers.

The first hidden layer of the NCSFNN 100 may be configured as the stochastic layer 101 and the second hidden layer may be configured as the deterministic layer 203.

The first hidden layer may be defined as a bindary random vector (that is, h¹ ∈ {0,1}^{N}^{¹}) having stochastic distribution expressed as following Equation 1.

$$P ( {h}^{1} ; x ) = {\prod }_{i = 1}^{{N}^{1}} P ( {h}_{i}^{1} ; x ) with \\ P ( {h}_{i}^{1} = 1 ; x ) = g ( {α}_{1} f ( {W}_{i}^{1} x + {b}_{i}^{1} ) ) \qquad [ Equation 1 ]$$

wherein x is data to be learned, N1 is the number of hidden units of the first layer, Wᵢ¹ is an i-th weight matrix of the first layer, bᵢ¹ is an i-th bias of the first layer, f: [symbol] → [symbol] + is a non-negative activation function (for example, ReLU or sigmoid), g(x)=min(max(x,0), 1), and α₁>0 is a hyper parameter of the first layer.

The second hidden layer may be defined as a deterministic vector (that is, h² ∈ [symbol] ^{N}^{²}) expressed as following Equation 2.

h²(x)=[f(α₂( [symbol] _{P(h}_{¹}_{;x)} [s(Wⱼ²h¹+bⱼ²)]−s(0))):∀j ∈ N²] [Equation 2]

wherein α₂>0 is a hyper parameter of the second layer, and s: [symbol] → [symbol] is a non-linear activation function (for example, sigmoid or tan h).

The first hidden layer of the NCSFNN 100 may be defined as a binary random vector having the marginal distribution defined as following Equation 1. Each of hidden units may have an independent property. The probability of the hidden unit to be ‘1’ may be determined using non-negative activation function f, such as ReLU or sigmoid, and function g(x)=min(max(x,0), 1) which bounds function value ‘0’ into ‘1’.

In the case of the second hidden layer, a model may be designed to represent a more complex relation by defining the second hidden layer with additional activation function s: [symbol] → [symbol] and expectations of stochastic neurons.

Next, a multi-hidden layer model having at least three hidden layers may be defined by replacing some layers of the DNN defined as following Equation 3 with the stochastic layer 101 defined as Equation 1 and replacing the layer above the stochastic layer 101 with the deterministic layer 203 which is a non-stochastic layer and defined as Equation 2.

ĥ^{l}(x)=[ĥᵢ^{l}(x)=f(Ŵᵢ^{l}ĥ^{l-1}(x)+\hat{b}ᵢ^{l}):i ∈ N^{l}] [Equation 3]

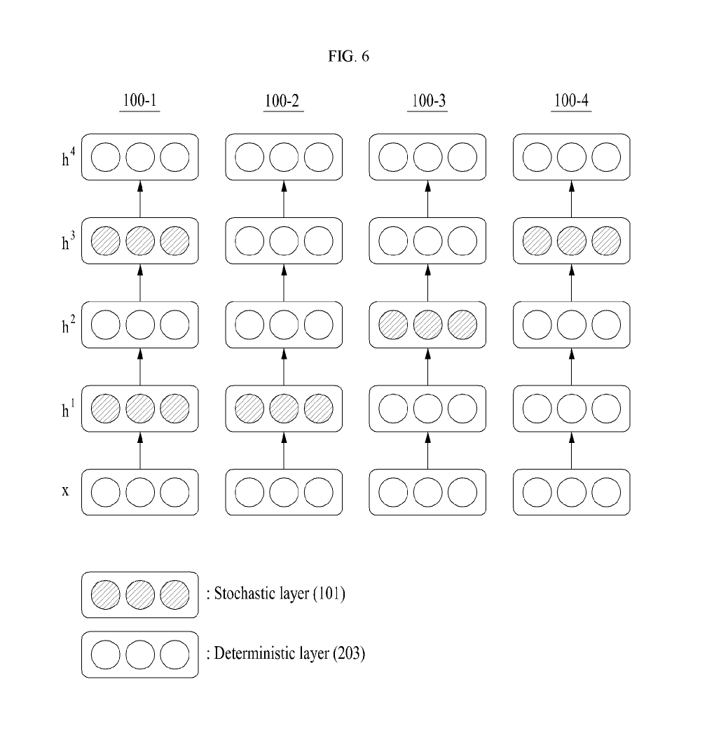

FIG. 6 is a view illustrating an example of a multi-hidden layer according to an embodiment of the inventive concept. FIG. 6 illustrates an NCSFNN having four hidden layers 100-1, 100-2, 100-3 and 100-4.

At least one of the hidden layers may be configured as the stochastic layer 101 and the other layers may be configured as non-stochastic layers 203. In this case, there is a structural limitation that the stochastic layers 101 constituting the NCSFNN 100-1, 100-2, 100-3 and 100-4 should be non-consecutive and the last layer should be configured as a non-stochastic layer 203. For example, as shown in FIG. 6, the first and third layers of the hidden layers 100-1 may be configured as the stochastic layer 101, only the first layer 100-2 may be configured as the stochastic layer 101, only the second layer 100-3 may be configured as the stochastic layer 101, or only the third layer 100-4 may be configured as the stochastic layer 101. In the cases 100-1, 100-2, 100-3 and 100-4 described above, all the last layers may be configured as the non-stochastic layer 203.

It is possible to transfer knowledge between the conventional DNN and the NSCFNN through such a structural limitation.

In the embodiment of the inventive concept, when it is assumed that the DNN and the NCSFNN have the same network structure and the parameters of all stochastic layers l in the NCSFNN are set through linear transformation expressed as following Equation 4, the same function value as that of the DNN may be expressed in the range of errors bounded as following Equation 5.

$$\begin{matrix}{α}_{𝓁} ← \frac{1}{{γ}_{𝓁}} , ( {α}_{𝓁 + 1} , {W}^{𝓁 + 1} , {b}^{𝓁 + 1} ) ← ( \frac{{γ}_{𝓁} {γ}_{𝓁 + 1}}{{s}^{′} ( 0 )} , \frac{{\hat{W}}^{𝓁 + 1}}{{γ}_{𝓁 + 1}} , \frac{{\hat{b}}^{𝓁 + 1}}{{γ}_{𝓁} {γ}_{𝓁 + 1}} ) \\ wherein \\ {γ}_{𝓁} = {max}_{i , x ∈ D} \vert f ( {\hat{W}}_{i}^{𝓁} {h}^{𝓁 - 1} ( x ) + {\hat{b}}_{i}^{𝓁} ) \vert and \\ {γ}_{𝓁 + 1} is any positive constant & [ Equation 4 ] \\ {lim}_{{γ}_{𝓁 + 1} \to ∞ \\ ∀ stochastic hidden layer 𝓁} \vert {h}_{j}^{L} ( x ) - {\hat{h}}_{j}^{L} ( x ) \vert = 0 , ∀ j , x ∈ D & [ Equation 5 ]\end{matrix}$$

When the parameter of the DNN is given and the parameter of the NCSFNN is set through linear transformation by using it, the NCSFNN may have the same function value as that of the DNN. This represents that it is possible to transfer knowledge between the NCSFNN and the DNN.

By using the fact that it is possible to transfer knowledge between the DNN and the NCSFNN, the following two-stage learning scheme may be applied to the learning of the NCSFFN: (1) the DNN capable of learning rapidly may be allowed to first learn, and (2) the parameter of the learned DNN is set as the parameter of the NCSFNN by using Equation 4. As merits of the two-stage learning scheme, by using the DNN capable of learning rapidly, the learning time of the NCSFNN may be reduced and the performance of the NCSFNN may be improved.

Next, like the conventional DNN, the learning of the NCSFNN is performed through back-propagation using a gradient. In the case of the NCSFNN, since it is impossible to obtain an exact gradient of the expectation shown in Equation 2, the NCSFNN may use gradient estimation based on Monte Carlo estimation as Equation 6 and Equation 7.

$$\begin{matrix}\frac{\partial }{\partial {W}_{j}^{2}} {P ( {h}^{1} ; x )}_{} [ s ( {W}_{j}^{2} {h}^{1} + {b}_{j}^{2} ) ] ≃ \frac{1}{M} {\sum }_{m} \frac{\partial }{\partial {W}_{j}^{2}} s ( {W}_{j}^{2} {h}^{( m )} + {b}_{j}^{2} ) & [ Equation 6 ] \\ \frac{\partial }{\partial {W}_{i}^{1}} {P ( {h}^{1} ; x )}_{} [ s ( {W}_{j}^{2} {h}^{1} + {b}_{j}^{2} ) ] ≃ \frac{{W}_{ij}^{2}}{M} {\sum }_{m} {s}^{′} ( {W}_{j}^{2} {h}^{( m )} + {b}_{j}^{2} ) \frac{\partial }{\partial {W}_{i}^{1}} P ( {h}_{i}^{1} = 1 ; x ) \\ wherein \\ {h}^{( m )} \text{∼} P ( {h}^{1} ; x ) and M is the number of samples . & [ Equation 7 ]\end{matrix}$$

wherein h^{(m)}˜P(h¹;x) and M is the number of samples

According to the embodiment, it is possible to provide a scheme of designing a novel deep learning model which is capable of making good performance in a supervised learning situation such as recognition and classification of things even though having the same number of variables as that of variables of a conventional deep learning model, and an effective learning scheme capable of allowing the corresponding model to learn rapidly.

In addition, according to the embodiment, the learning time may be reduced by using knowledge transfer between the non-stochastic model and the stochastic model, and fast and excellent performance may be obtained by setting the initial values of a learning model by using parameters of the non-stochastic model.

The learning method of the inventive concept may include at least two operations based on the details described with reference to FIGS. 1 to 6. The learning system according to the inventive concept may include at least one processor configured to execute an instruction readable by the computer, wherein the at least one processor may perform the learning method described with reference to FIGS. 1 to 6.

The above-described devices may be realized by hardware elements, software elements and/or combinations thereof. For example, the devices and elements illustrated in the exemplary embodiments of the inventive concept may be implemented in one or more general-use computers or special-purpose computers, such as a processor, a controller, an arithmetic logic unit (ALU), a digital signal processor, a microcomputer, a field programmable gate array (FPGA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. In addition, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A learning method comprising:
configuring a non-consecutive stochastic feedforward neural network (NCSFNN) having non-consecutive stochastic neuron as a leaning model including a plurality of hidden layers; and
allowing the NCSFNN to learn.

2. The learning method of claim 1, wherein the configuring of the NCSFNN comprises configuring a last layer of the NCSFNN as a non-stochastic neuron.

3. The learning method of claim 1, wherein the configuring of the NCSFNN comprises configuring the NCSFNN by replacing at least one of a deep neural network (DNN) with a stochastic layer.

4. The learning method of claim 1, wherein the configuring of the NCSFNN comprises configuring at least one among the hidden layers with a stochastic layer and configuring a last layer with a non-stochastic layer.

5. The learning method of claim 4, wherein the configuring of the NCSFNN comprises configuring a layer connected to an output of the stochastic layer with a deterministic layer.

6. The learning method of claim 4, wherein the stochastic layer is defined as a binary random vector having marginal distribution expressed as follows:
$$P ( {h}^{1} ; x ) = {\prod }_{i = 1}^{{N}^{1}} P ( {h}_{i}^{1} ; x ) with$$
$$P ( {h}_{i}^{1} = 1 ; x ) = g ( {α}_{1} f ( {W}_{i}^{1} x + {b}_{i}^{1} ) )$$
wherein x is data to be learned, N1 is a number of hidden units of the stochastic layer, Wᵢ¹ is an i-th weight matrix of the stochastic layer, bᵢ¹ is an i-th bias of the stochastic layer, f: [symbol] → [symbol] + is a non-negative activation function, and g(x)=min(max(x,0), 1), α₁>0 is a parameter of the stochastic layer.

7. The learning method of claim 4, wherein the non-stochastic layer is defined as a deterministic vector expressed as follows:
h²(x)=[f(α₂( [symbol] _{P(h}_{¹}_{;x)} [s(Wⱼ²h¹+bⱼ²)]−s(0))):∀j ∈ N²]
wherein x is data to be learned, N2 is a number of hidden units of the non-stochastic layer, Wⱼ² is an j-th weight matrix of the non-stochastic layer, bⱼ² is an j-th bias of the non-stochastic layer, f: [symbol] → [symbol] + is a non-negative activation function, α₂>0 is a parameter of the non-stochastic layer, and s: [symbol] → [symbol] is a non-linear activation function.

8. The learning method of claim 1, wherein the allowing of the NCSFNN to learn is performed based on a knowledge transfer and gradient estimation

9. The learning method of claim 3, wherein the allowing of the NCSFNN to learn comprises setting a parameter of the NCSFNN through linear transformation by using a parameter of the DNN.

10. The learning method of claim 3, wherein the allowing of the NCSFNN to learn comprises allowing the NCSFNN to learn in a two-stage learning scheme of allowing the DNN to learn and allowing the NCSFNN to learn after a parameter of the NCSFNN is set by using a parameter of the DNN learned.

11. The learning method of claim 1, wherein the NCSFNN is used for supervised learning for recognizing a thing or a voice.

12. A learning method comprising:
configuring a non-consecutive stochastic feedforward neural network (NCSFNN) by replacing at least one non-consecutive layer with a stochastic layer in a deep neural network (DNN) including a plurality of hidden layers; and
allowing the NCSFNN to learn based on a knowledge transfer and gradient estimation.

13. The learning method of claim 12, wherein the configuring of the NCSFNN comprises configuring a last layer among the hidden layers with a non-stochastic layer.

14. The learning method of claim 13, wherein the configuring of the NCSFNN comprises configuring a layer connected to an output of the stochastic layer with a deterministic layer.

15. The learning method of claim 12, wherein the NCSFNN is used for supervised learning for recognizing a thing or a voice.

16. A learning method comprising:
configuring a non-consecutive stochastic feedforward neural network (NCSFNN) by replacing at least one non-consecutive layer with a stochastic layer in a deep neural network including a plurality of hidden layers; and
allowing the NCSFNN to learn in a two-stage learning scheme of allowing the DNN to learn and allowing the NCSFNN to learn after a parameter of the NCSFNN is set by using a parameter of the DNN learned.

17. The learning method of claim 16, wherein the configuring of the NCSFNN comprises configuring a last layer among the hidden layers with a non-stochastic layer.

18. The learning method of claim 17, wherein the configuring of the NCSFNN comprises configuring a layer connected to an output of the stochastic layer with a deterministic layer.

19. The learning method of claim 16, wherein the NCSFNN is used for supervised learning for recognizing a thing or a voice.

20. A learning system implemented by a computer, the learning system comprising at least one processor implemented to execute an instruction readable by the computer,
wherein the at least one processor configures a non-consecutive stochastic feedforward neural network (NCSFNN) by replacing at least one non-consecutive layer with a stochastic layer in a deep neural network (DNN) including a plurality of hidden layers.

21. The learning system of claim 20, wherein the at least one processor configures a last layer among the hidden layers as a non-stochastic layer to configure the NCSFNN.

22. The learning system of claim 20, wherein the at least one processor allows the NCSFNN to learn based on a knowledge transfer and gradient estimation, and
wherein the at least one processor allows the NCSFNN to learn a two-stage learning scheme of allowing the DNN to learn and allowing the NCSFNN to learn after a parameter of the NCSFNN is set by using a parameter of the DNN learned.

23. The learning system of claim 20, wherein the at least one processor uses the NCSFNN for supervised learning for recognizing a thing or a voice.
